(19) United States
(12) Patent Application Publication
(10) Pub. No.: US 2026/0353270 A1
(43) Pub. Date: Nov. 5, 2026

(54) CONDITIONAL CELL CONFIGURATION UPDATE

(71) Applicant: NOKIA TECHNOLOGIES OY, Espoo (FI)

(72) Inventors: Srinivasan SELVAGANAPATHY, Bangalore (IN); Ahmad AWADA, Munich (DE); Halit Murat GÜRSU, Munich (DE); Amaanat ALI, Espoo (FI); Umur KARABULUT, Munich (DE)

(21) Appl. No.: 19/101,758

(22) PCT Filed: Aug. 7, 2023
(86) PCT No.: PCT/EP2023/071841

§ 371 Date: Feb. 6, 2025

(30) Foreign Application Priority Data
Aug. 10, 2022 (IN) 202241045669

(51) Int. Cl. H04W 48/20; H04W 48/16

(52) U.S. Cl. CPC H04W 48/20; H04W 48/16

(57) ABSTRACT

A method comprising receiving, during service from a first cell having a first configuration comprising at least one parameter, a conditional configuration for each of at least one further cell, each conditional configuration comprising at least one parameter; generating information during service from the first cell, the information comprising at least one changed parameter required to be changed to provide the first configuration from the conditional configuration for each of the at least one further cell and a corresponding value for each of the at least one changed parameter to provide the first configuration from the conditional configuration for each of the at least one further cell; and storing the information.

### FIELD

The present application relates to a method, apparatus, system and computer program.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite-based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to a first aspect, there is provided a method comprising: receiving, during service from a first cell having a first configuration comprising at least one parameter, a conditional configuration for each of at least one further cell, each conditional configuration comprising at least one parameter; generating information during service from the first cell, the information comprising at least one changed parameter required to be changed to provide the first configuration from the conditional configuration for each of the at least one further cell and a corresponding value for each of the at least one changed parameter to provide the first configuration from the conditional configuration for each of the at least one further cell; and storing the information.

According to some examples, the information comprises a short roll-back configuration.

According to some examples, the method comprises receiving an indication from a network node to preserve configurations when switching service from the first cell to the at least one further cell.

According to some examples, the method is performed by a User Equipment.

According to some examples, the information is stored in a list comprising a respective entry corresponding to each of the at least one further cell.

According to some examples, the method comprises: determining to switch to service from the first cell to service from a second cell, the at least one further cell comprising the second cell; based on the information, storing a reference configuration for changing from the configuration of the second cell to the first configuration of the first cell; and switching to service to the second cell and applying the configuration of the second cell.

According to some examples, the method comprises: determining to switch to service from the second cell to service from the third cell, the at least one further cell comprising the third cell; applying the reference configuration to change to the first configuration of the first cell and then applying the configuration of the third cell to change to the configuration of the third cell; based on the information, storing a new reference configuration for changing from the configuration of the third cell to the first configuration of the first cell.

According to some examples, the method comprises: receiving an updated configuration for the second cell; applying the updated configuration for the second cell; updating the information based on the updated configuration of the second cell; updating, based on the updated information, the reference configuration for changing from the configuration of the second cell to the first configuration of the first cell.

According to some examples, the method comprises: sending, to the network node, an indication indicating an update, based on the updated information, of the reference configuration for changing from the configuration of the second cell to the first configuration of the first cell; and wherein: the receiving an updated configuration for the second cell comprises receiving a signalling message from the network node, wherein the network node determines to send the signalling message based on receiving a capability indication from the user equipment.

According to some examples the signalling message may comprise a Radio Resource Control message.

According to some examples, each conditional configuration is a delta configuration describing a parameter change required to change from the first configuration to the conditional configuration.

According to some examples, the method comprises: sending to a network node, an indication of the capability of generating information for changing of each the at least one changed parameter from the conditional configuration for each of the least one further cell to the first configuration.

According to some examples, the network node indicates the capability to at least one other network node.

According to some examples, the network node comprises an MN.

According to some examples, the network node comprises an SN.

According to some examples, the at least one other network node comprises an SN.

According to some examples, the at least one other network node determines whether to send a full configuration describing each parameter of a configuration of the network node or a delta configuration describing a parameter change required to change from the first configuration to the configuration of the network node.

According to some examples, the first cell comprises a PSCell and the at least one further cell comprises a PSCell.

According to some examples, each of the first cell and the at least one further cell belong to a different Secondary Cell Group.

According to a second aspect, there is provided an apparatus comprising means for: receiving, during service from a first cell having a first configuration comprising at least one parameter, a conditional configuration for each of at least one further cell, each conditional configuration comprising at least one parameter; generating information during service from the first cell, the information comprising at least one changed parameter required to be changed to provide the first configuration from the conditional configuration for each of the at least one further cell and a corresponding value for each of the at least one changed parameter to provide the first configuration from the conditional configuration for each of the at least one further cell; and storing the information.

According to some examples, the information comprises a short roll-back configuration.

According to some examples, the means are for: receiving an indication from a network node to preserve configurations when switching service from the first cell to the at least one further cell.

According to some examples, the method is performed by a User Equipment.

According to some examples, the information is stored in a list comprising a respective entry corresponding to each of the at least one further cell.

According to some examples, the means are for: determining to switch to service from the first cell to service from a second cell, the at least one further cell comprising the second cell; based on the information, storing a reference configuration for changing from the configuration of the second cell to the first configuration of the first cell; and switching to service to the second cell and applying the configuration of the second cell.

According to some examples, the means are for: determining to switch to service from the second cell to service from the third cell, the at least one further cell comprising the third cell; applying the reference configuration to change to the first configuration of the first cell and then applying the configuration of the third cell to change to the configuration of the third cell; based on the information, storing a new reference configuration for changing from the configuration of the third cell to the first configuration of the first cell.

According to some examples, the means are for: receiving an updated configuration for the second cell; applying the updated configuration for the second cell; updating the information based on the updated configuration of the second cell; updating, based on the updated information, the reference configuration for changing from the configuration of the second cell to the first configuration of the first cell.

According to some examples, the means are for: sending, to the network node, an indication indicating an update, based on the updated information, of the reference configuration for changing from the configuration of the second cell to the first configuration of the first cell; and wherein: the receiving an updated configuration for the second cell comprises receiving a signalling message from the network node, wherein the network node determines to send the signalling message based on receiving a capability indication from the user equipment.

According to some examples the signalling message may comprise a Radio Resource Control message.

According to some examples, each conditional configuration is a delta configuration describing a parameter change required to change from the first configuration to the conditional configuration.

According to some examples, the means are for: sending to a network node, an indication of the capability of generating information for changing of each the at least one changed parameter from the conditional configuration for each of the least one further cell to the first configuration.

According to some examples, the network node indicates the capability to at least one other network node.

According to some examples, the network node comprises an MN.

According to some examples, the network node comprises an SN.

According to some examples, the at least one other network node comprises an SN.

According to some examples, the at least one other network node determines whether to send a full configuration describing each parameter of a configuration of the network node or a delta configuration describing a parameter change required to change from the first configuration to the configuration of the network node.

According to some examples, the first cell comprises a PSCell and the at least one further cell comprises a PSCell.

According to some examples, each of the first cell and the at least one further cell belong to a different Secondary Cell Group.

According to a third aspect, there is provided an apparatus comprising at least one processor and at least one memory storing instructions that, when executed by the at least one processor, cause the apparatus at least to: receiving, during service from a first cell having a first configuration comprising at least one parameter, a conditional configuration for each of at least one further cell, each conditional configuration comprising at least one parameter; generating information during service from the first cell, the information comprising at least one changed parameter required to be changed to provide the first configuration from the conditional configuration for each of the at least one further cell and a corresponding value for each of the at least one changed parameter to provide the first configuration from the conditional configuration for each of the at least one further cell; and storing the information.

According to some examples, the information comprises a short roll-back configuration.

According to some examples, the at least one memory and the computer program code are configured to, with the at least one processor, cause the apparatus at least to perform: receiving an indication from a network node to preserve configurations when switching service from the first cell to the at least one further cell.

According to some examples, the apparatus comprises a User Equipment.

According to some examples, the information is stored in a list comprising a respective entry corresponding to each of the at least one further cell.

According to some examples, the at least one memory and the computer program code are configured to, with the at least one processor, cause the apparatus at least to perform: determining to switch to service from the first cell to service from a second cell, the at least one further cell comprising the second cell; based on the information, storing a reference configuration for changing from the configuration of the second cell to the first configuration of the first cell; and switching to service to the second cell and applying the configuration of the second cell.

According to some examples, the at least one memory and the computer program code are configured to, with the at least one processor, cause the apparatus at least to perform: determining to switch to service from the second cell to service from the third cell, the at least one further cell comprising the third cell; applying the reference configuration to change to the first configuration of the first cell and then applying the configuration of the third cell to change to the configuration of the third cell; based on the information, storing a new reference configuration for changing from the configuration of the third cell to the first configuration of the first cell.

According to some examples, the at least one memory and the computer program code are configured to, with the at least one processor, cause the apparatus at least to perform: receiving an updated configuration for the second cell; applying the updated configuration for the second cell; updating the information based on the updated configuration of the second cell; updating, based on the updated information, the reference configuration for changing from the configuration of the second cell to the first configuration of the first cell.

According to some examples, the at least one memory and the computer program code are configured to, with the at least one processor, cause the apparatus at least to perform: sending, to the network node, an indication indicating an update, based on the updated information, of the reference configuration for changing from the configuration of the second cell to the first configuration of the first cell; and wherein: the receiving an updated configuration for the second cell comprises receiving a signalling message from the network node, wherein the network node determines to send the signalling message based on receiving a capability indication from the user equipment.

According to some examples the signalling message may comprise a Radio Resource Control message.

According to some examples, each conditional configuration is a delta configuration describing a parameter change required to change from the first configuration to the conditional configuration.

According to some examples, the at least one memory and the computer program code are configured to, with the at least one processor, cause the apparatus at least to perform: sending to a network node, an indication of the capability of generating information for changing of each the at least one changed parameter from the conditional configuration for each of the least one further cell to the first configuration.

According to some examples, the network node indicates the capability to at least one other network node.

According to some examples, the network node comprises an MN.

According to some examples, the network node comprises an SN.

According to some examples, the at least one other network node comprises an SN.

According to some examples, the at least one other network node determines whether to send a full configuration describing each parameter of a configuration of the network node or a delta configuration describing a parameter change required to change from the first configuration to the configuration of the network node.

According to some examples, the first cell comprises a PSCell and the at least one further cell comprises a PSCell.

According to some examples, of the first cell and the at least one further cell belong to a different Secondary Cell Group.

According to a fourth aspect there is provided an apparatus comprising: circuitry for:

According to a fifth aspect there is provided a computer program comprising instructions for causing an apparatus to perform at least the following: receiving, during service from a first cell having a first configuration comprising at least one parameter, a conditional configuration for each of at least one further cell, each conditional configuration comprising at least one parameter; generating information during service from the first cell, the information comprising at least one changed parameter required to be changed to provide the first configuration from the conditional configuration for each of the at least one further cell and a corresponding value for each of the at least one changed parameter to provide the first configuration from the conditional configuration for each of the at least one further cell; and storing the information.

According to a sixth aspect there is provided a computer program comprising instructions stored thereon for performing at least the following: receiving, during service from a first cell having a first configuration comprising at least one parameter, a conditional configuration for each of at least one further cell, each conditional configuration comprising at least one parameter; generating information during service from the first cell, the information comprising at least one changed parameter required to be changed to provide the first configuration from the conditional configuration for each of the at least one further cell and a corresponding value for each of the at least one changed parameter to provide the first configuration from the conditional configuration for each of the at least one further cell; and storing the information.

According to a seventh aspect there is provided a non-transitory computer readable medium comprising program instructions for causing an apparatus to perform at least the following: receiving, during service from a first cell having a first configuration comprising at least one parameter, a conditional configuration for each of at least one further cell, each conditional configuration comprising at least one parameter; generating information during service from the first cell, the information comprising at least one changed parameter required to be changed to provide the first configuration from the conditional configuration for each of the at least one further cell and a corresponding value for each of the at least one changed parameter to provide the first configuration from the conditional configuration for each of the at least one further cell; and storing the information.

According to an eighth aspect there is provided a non-transitory computer readable medium comprising program instructions stored thereon for performing at least the following: receiving, during service from a first cell having a first configuration comprising at least one parameter, a conditional configuration for each of at least one further cell, each conditional configuration comprising at least one parameter; generating information during service from the first cell, the information comprising at least one changed parameter required to be changed to provide the first configuration from the conditional configuration for each of the at least one further cell and a corresponding value for each of the at least one changed parameter to provide the first configuration from the conditional configuration for each of the at least one further cell; and storing the information.

According to a ninth aspect there is provided a method comprising: receiving, from a User Equipment, an indication of a capability of the User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and performing at least one of: sending, to the User Equipment, at least one conditional configuration for at least one further cell; and indicating to a network node to send, to the User Equipment, at least one conditional configuration for at least one further cell.

According to some examples, the method comprises: sending, to the User Equipment, a request for the indication of the capability of the User Equipment to generate the information.

According to some examples, the method comprises: sending, to at least one network node, the indication of the capability of the User Equipment to generate the information.

According to some examples, the method comprises: receiving a second indication from the User Equipment, the second indication indicating a capability of the User Equipment to update the first configuration; sending signalling to the User Equipment to update the first configuration.

According to some examples, the signalling comprises an RRC message.

According to some examples, the method is performed by a MN.

According to some examples, the network node comprises an SN.

According to a tenth aspect there is provided an apparatus comprising: at least one processor; and at least one memory including computer program code; the at least one memory and the computer program code configured to, with the at least one processor, cause the apparatus at least to perform: receiving, from a User Equipment, an indication of a capability of the User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and performing at least one of: sending, to the User Equipment, at least one conditional configuration for at least one further cell; and indicating to a network node to send, to the User Equipment, at least one conditional configuration for at least one further cell.

According to some examples, the at least one memory and the computer program code are configured to, with the at least one processor, cause the apparatus at least to perform: sending, to the User Equipment, a request for the indication of the capability of the User Equipment to generate the information.

According to some examples, the at least one memory and the computer program code are configured to, with the at least one processor, cause the apparatus at least to perform: sending, to at least one network node, the indication of the capability of the User Equipment to generate the information.

According to some examples, the at least one memory and the computer program code are configured to, with the at least one processor, cause the apparatus at least to perform: receiving a second indication from the User Equipment, the second indication indicating a capability of the User Equipment to update the first configuration; sending signalling to the User Equipment to update the first configuration.

According to some examples, the signalling comprises an RRC message.

According to some examples, the apparatus comprises a MN.

According to some examples, the network node comprises an SN.

According to an eleventh aspect there is provided an apparatus comprising means for: receiving, from a User Equipment, an indication of a capability of the User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and performing at least one of: sending, to the User Equipment, at least one conditional configuration for at least one further cell; and indicating to a network node to send, to the User Equipment, at least one conditional configuration for at least one further cell.

According to some examples, the means are for: sending, to the User Equipment, a request for the indication of the capability of the User Equipment to generate the information.

According to some examples, the means are for: sending, to at least one network node, the indication of the capability of the User Equipment to generate the information.

According to some examples, the means are for: receiving a second indication from the User Equipment, the second indication indicating a capability of the User Equipment to update the first configuration; sending signalling to the User Equipment to update the first configuration.

According to some examples, the signalling comprises an RRC message.

According to some examples, the method is performed by a MN.

According to some examples, the network node comprises an SN.

According to a twelfth aspect there is provided an apparatus comprising: circuitry for: receiving, from a User Equipment, an indication of a capability of the User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and performing at least one of: sending, to the User Equipment, at least one conditional configuration for at least one further cell; and indicating to a network node to send, to the User Equipment, at least one conditional configuration for at least one further cell.

According to a thirteenth aspect there is provided a computer program comprising instructions for causing an apparatus to perform at least the following: receiving, from a User Equipment, an indication of a capability of the User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and performing at least one of: sending, to the User Equipment, at least one conditional configuration for at least one further cell; and indicating to a network node to send, to the User Equipment, at least one conditional configuration for at least one further cell.

According to a fourteenth aspect there is provided a computer program comprising instructions stored thereon for performing at least the following: receiving, from a User Equipment, an indication of a capability of the User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and performing at least one of: sending, to the User Equipment, at least one conditional configuration for at least one further cell; and indicating to a network node to send, to the User Equipment, at least one conditional configuration for at least one further cell.

According to a fifteenth aspect there is provided a non-transitory computer readable medium comprising program instructions for causing an apparatus to perform at least the following: receiving, from a User Equipment, an indication of a capability of the User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and performing at least one of: sending, to the User Equipment, at least one conditional configuration for at least one further cell; and indicating to a network node to send, to the User Equipment, at least one conditional configuration for at least one further cell.

According to an sixteenth aspect there is provided a non-transitory computer readable medium comprising program instructions stored thereon for performing at least the following: receiving, from a User Equipment, an indication of a capability of the User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and performing at least one of: sending, to the User Equipment, at least one conditional configuration for at least one further cell; and indicating to a network node to send, to the User Equipment, at least one conditional configuration for at least one further cell.

According to a seventeenth aspect there is provided a method comprising: receiving, from a network node, an indication of a capability of a User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and sending a conditional configuration for at least one further cell to the User Equipment.

According to some examples, the conditional configuration comprises a delta configuration describing a parameter change required to change from the first configuration to the conditional configuration.

According to some examples, the method is performed by a SN.

According to some examples, the network node comprises an MN.

According to an eighteenth aspect there is provided an apparatus comprising: at least one processor; and at least one memory including computer program code; the at least one memory and the computer program code configured to, with the at least one processor, cause the apparatus at least to perform: receiving, from a network node, an indication of a capability of a User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and sending a conditional configuration for at least one further cell to the User Equipment.

According to some examples, the conditional configuration comprises a delta configuration describing a parameter change required to change from the first configuration to the conditional configuration.

According to some examples, the apparatus comprises a SN.

According to some examples, the network node comprises an MN.

According to an nineteenth aspect there is provided an apparatus comprising means for: receiving, from a network node, an indication of a capability of a User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and sending a conditional configuration for at least one further cell to the User Equipment.

According to some examples, the conditional configuration comprises a delta configuration describing a parameter change required to change from the first configuration to the conditional configuration.

According to some examples, the apparatus comprises a SN.

According to some examples, the network node comprises an MN.

According to a twentieth aspect there is provided an apparatus comprising: circuitry for: receiving, from a network node, an indication of a capability of a User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and sending a conditional configuration for at least one further cell to the User Equipment.

According to a twenty-first aspect there is provided a computer program comprising instructions for causing an apparatus to perform at least the following: receiving, from a network node, an indication of a capability of a User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and sending a conditional configuration for at least one further cell to the User Equipment.

According to a twenty-second aspect there is provided a computer program comprising instructions stored thereon for performing at least the following: receiving, from a network node, an indication of a capability of a User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and sending a conditional configuration for at least one further cell to the User Equipment.

According to a twenty-third aspect there is provided a non-transitory computer readable medium comprising program instructions for causing an apparatus to perform at least the following: receiving, from a network node, an indication of a capability of a User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and sending a conditional configuration for at least one further cell to the User Equipment.

According to a twenty-fourth aspect there is provided a non-transitory computer readable medium comprising program instructions stored thereon for performing at least the following: receiving, from a network node, an indication of a capability of a User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and sending a conditional configuration for at least one further cell to the User Equipment.

According to an aspect, there is provided a non-transitory computer readable medium comprising program instructions that, when executed by an apparatus, cause the apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows an example of a network system according to some example embodiments;

FIG. 5 shows an example method flow;

FIG. 6 shows an example method flow;

FIG. 7 shows an example method flow;

FIG. 8 shows an example method flow;

FIG. 9 shows an example method flow;

FIG. 10 shows an example method flow;

FIG. 11 shows an example method flow;

FIG. 12 shows a schematic representation of a non-volatile memory medium storing instructions which when executed by a processor allow a processor to perform one or more of the steps of the method of FIGS. 5 to 10.

### DETAILED DESCRIPTION

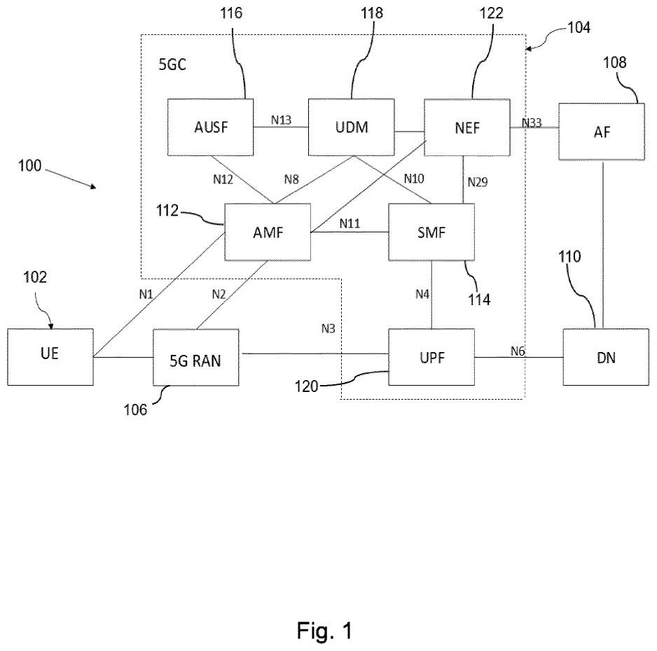

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS) 100. 5GS 100 may be comprised by a terminal or user equipment (UE) 102, a 5G radio access network (5GRAN) 106 or next generation radio access network (NG-RAN), a 5G core network (5GC) 104, at least one application function (AF) 108 and at least one data network (DN) 110.

5G-RAN 106 may comprise one or more gNodeB (GNB) or one or more gNodeB (GNB) distributed unit functions connected to one or more gNodeB (GNB) centralized unit functions. 5GC 104 may comprise the following entities: Network Slice Selection Function (NSSF); Network Exposure Function (NEF) 122; Network Repository Function (NRF); Policy Control Function (PCF); Unified Data Management (UDM) 118; Application Function (AF); Authentication Server Function (AUSF) 116; an Access and Mobility Management Function (AMF) 112; and Session Management Function (SMF) 114.

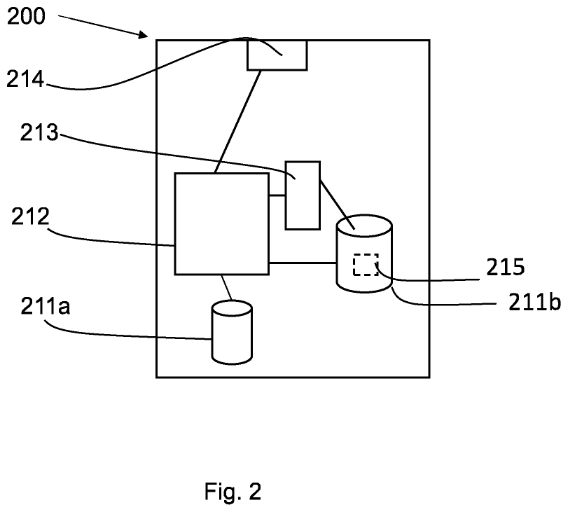

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

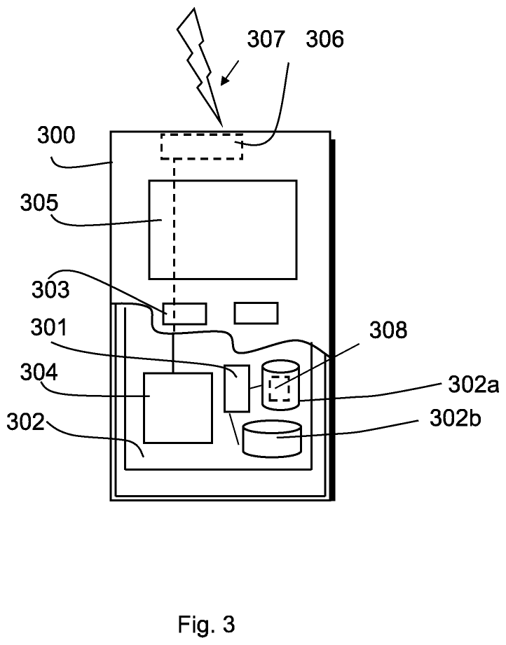

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

For 5G NR, support may be provided for selective activation of a cell-group (CG) to enable mobility across CGs without additional reconfiguration related signalling.

In existing conditional mobility features, i.e., Conditional PSCell Addition and Change (CPAC)/Conditional Handover (CHO) specified in Rel-16 and Rel-17, conditional configurations are always released after CHO/CPAC execution. In case the UE moves from the serving cell to one of the target cells which was already prepared, the CPAC/CHO preparation (and associated signalling overhead/RRC signalling) needs to be performed again to provide the UE with new conditional configurations that are needed for subsequent cell changes. These additional steps may delay fast mobility across different cell group.

According to some examples, multiple cell-group configurations are stored at a UE to enable selective activations.

An exemplary scenario for selective activation is the configuration of a UE for Conditional PSCell Addition/Change (CPAC). Considering in one scenario, a survival of the CPAC related configurations and conditions after the initial cell change execution from a current serving cell is achieved. The survival of CPAC related configuration means that CPAC configurations are not released after serving cell change execution. It is to be evaluated whether the survived CPAC configuration is still usable/applicable. For this scenario, the target cell configurations provided to the UE as part of Conditional PSCell Addition/Change (CPAC) configurations (including condition when to execute cell change and configuration to apply in target cell) are typically delta configurations. In a delta configuration, a configuration is defined relative to the current serving cell configuration. For CPAC, a delta configuration over a current serving SCG configuration may be provided. After execution of CPAC to one target-cell, the serving cell configuration is changed to new cell configuration. The stored CPAC configurations which are ‘delta’ configurations relative to the previous serving cell configuration cannot be used as such for further CPAC execution. The CPAC survival after initial execution in this scenario will not work without resolving this issue.

According to some of the following examples, CPAC is defined for and is applicable to an initial serving cell, C1. A first cell change where CPAC execution is performed into a new/first target cell C2. A second target cell C3 is also provided. In some examples CPAC execution may be performed from C2 to C3.

According to some examples, a CPAC Survival message sequence is provided.

Consider an example of a UE in Dual Connectivity for a serving Secondary Cell Group (SCG) with PSCell C1. Conditional PSCell Change (CPC) configurations are prepared for Target PSCells C2 and C3. Target configurations C2 and C3 are provided as ‘delta configuration’ over C1.

When CPC configurations for Target PSCells C2 and C3 are received at the UE, the UE generates a configuration for each target PSCell. The configuration may comprise parameters for each respective target PSCell, In some examples each configuration for each target PSCell is considered a “short roll-back configuration”. The configuration for each target PSCell is determined as:
Current values of the parameters modified in Target configuration (CPC configuration) is maintained in the short-reference-configuration.
If the target configuration includes new parameter which was optional the short configuration maintains the default value for this parameter.
If target configuration includes additional entry for parameter such as addition of secondary-cells, the short-reference-configuration maintains it as ‘release of the secondary-cells’.

Considering an example where the UE switches to C2 as part of CPC execution, the UE then selects the configuration that corresponds to target cell C2 (the short roll-back configuration) and maintains (stores) the selected configuration that corresponds to target cell C2 as a reference roll-back configuration for CPC survival. The selected configuration can then be used at a later time if CPC execution is performed to a further target cell (e.g., C3).

According to some examples, a UE being served by an initial serving cell determines that a condition to change into cell C2 is met/applied. The UE may then start to execute CPC by the UE selecting, the CPC configuration corresponding to C2. Before starting to operate with the CPC configuration in the cell C2, the UE may define the current serving cell as a reference cell or as an initial serving cell, and the UE may then select/define the short roll-back configuration (which has been generated earlier) for target cell C2 as reference roll-back configuration which is to apply when leaving cell C2. The reference roll-back configuration will restore the configuration of the reference cell, (i.e., the UE executes the reference roll-back configuration when/before UE leaves the cell C2 towards a further cell C3 to restore the settings of the reference cell C1). The UE can then take the CPC configuration of target cell C2 into operation. At this stage, the UE operates with CPC configuration in cell C2 and determines if a condition to change the serving cell is met/applies. At a later point in time when the UE switches to cell C3, the roll-back configuration that corresponds to target cell C2 (short roll-back configuration) is applied over configuration of cell C2 as delta configuration that will bring back the initial serving cell configuration (the configuration of PSCell C1) without the need for a full re-configuration. The C3 configuration is then applied over this configuration of initial serving cell. The short roll-back configuration is now also switched to C3 specific short configuration for further switching from C3 to any further cell.

The above example method can be extended for reconfiguration of parameters in any target cell after initial switching with following additional changes. The reference short-rollback configuration can be updated with a current value of a serving cell configuration whenever the serving cell configuration changes a specific parameter. If the network intends to use the modified parameter for later switching to the same cell, it can indicate this intention in signalling (e.g., a RRC Reconfiguration message). To make this indication, signalling may comprise a new information element, which in some examples may be the flag “update-selective-activation-config” or an indicator with a value which expresses this intention.

When a UE receives signalling with an indication that the network intends to use the modified parameter for later switching to the same cell (e.g., RRC-Reconfiguration with update-selective-activation-config (or any other similar indication)), the UE will also update the configuration of the current-cell stored in selective activation with the received values. With this change later switching to this cell will have the latest configuration.

In some examples, the network may indicate to a UE that the UE should apply and follow the steps and configuration modifications defined herein for fast configuration switching capability/selective cell activation and roll-back behaviour when the network sends the conditional configurations of the target cells to the UE.

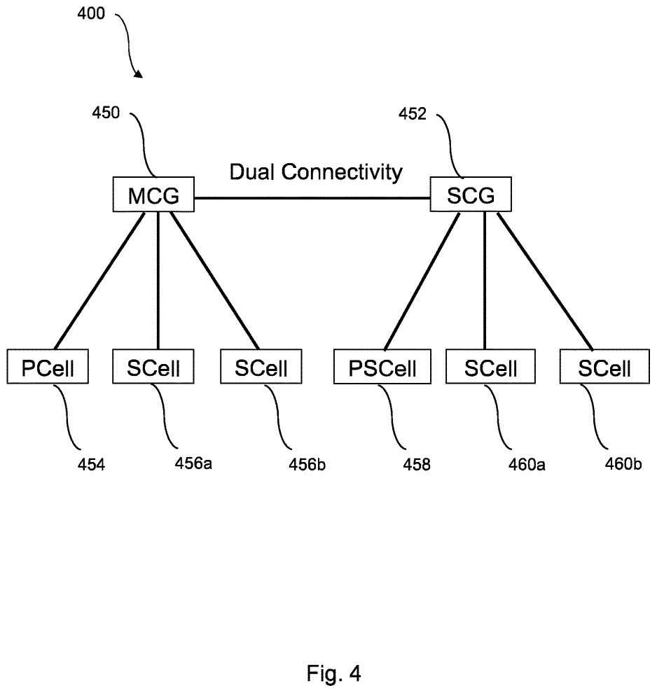

FIG. 4 shows a system 400 in which some examples may be performed. System 400 comprises Master Cell Group (MCG) 450 and a Secondary Cell Group (SCG) 452. System 400 may also comprise other SCGs, each having a PSCell. Each of the of other SCGs may also have one or more SCells. According to some examples, a UE may switch between PSCells of two or more SCGs. Switching between PSCells may comprise CPAC execution.

MCG 450 comprises a Primary Cell (PCell) 454. PCell 454 may be used to initiate initial access for a UE. MCG 450 may also comprise other cells comprising at least one Secondary Cell (SCell) 456a and 456b.

MCG 450 may be controlled by a Master Node (MN) 451.

MCG 450 is connected to SCG 452 by a Dual Connectivity (DC) system. SCG 452 comprises a Primary Secondary Cell (PSCell) 458 which may be used as a cell for which initial access is initiated for SCG 452. SCG 452 may also comprise other cells comprising at least one Secondary Cell (SCell) 460a and 460b.

SCG 452 may be controlled by a Secondary Node (SN) 453. Each SCG in system 400 may comprise a SN.

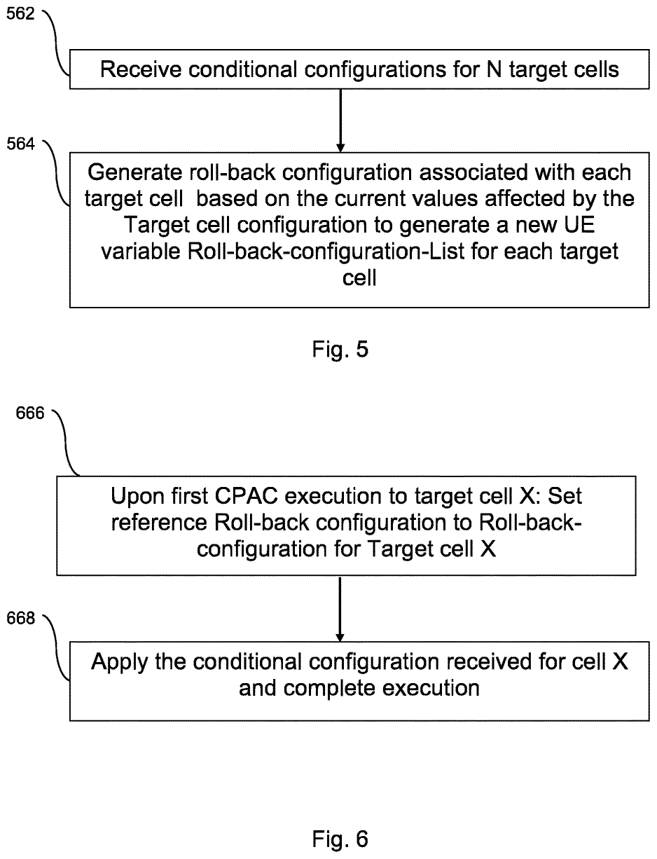

An example method performed by a UE is shown in FIG. 5. At 562, the UE receives conditional configurations for N target cells, where N is an integer value larger than 0. N may also indicate the maximum number of target cells supported within CG. According to some examples, the UE may receive the N target cells from a network node. The network node may comprise a Master Node (MN) in some examples. In other examples, the UE may receive the conditional configuration of a target cell from a target node.

At 564, the UE generates a list of information that can be used to return the UE's configuration back to the configuration for the UE's serving cell if the UE were to undergo CPAC execution to any of the target cells. Each target cell is provided with one or more list entries. As such, the UE generates roll-back configuration associated with each target cell based on the current serving cell values that will be affected once the Target cell configuration is applied to generate a new UE variable Roll-back-configuration-List for each target cell.

A specific example (example i)) is now considered with respect to FIG. 5. The UE uses an RRC Reconfiguration with affected parameters as A, B and C in this example. Prior to 562, a UE operates in DC with a current serving SCG configuration as shown in Table 1.

TABLE 1
Initial serving SCG configuration for parameters A, B and C

| | Parameter Name | Value |
|---|---|---|
| Source SCG Configuration | A | 1 |
| | B | 2 |
| | C | 3 |

In example i), at 562 the UE receives CPC configuration for PSCell 2 (C2) and PSCell 3 (C3). The configuration for C2 is shown in Table 2 and the configuration for C3 is shown in Table 3. The received configurations are “delta configurations” with respect to the current serving SCG configuration. Values not modified from the current serving SCG configuration are not part of these delta configurations. C2 configuration only changes A and B so only A and B values are given. C3 configuration only changes A and C so only A and C values are given.

TABLE 2
Received Conditional Configurations for CPC of PSCell C2

| | Parameter Name | Value |
|---|---|---|
| Conditional Configuration 1 (for PSCell C2) | A | 5 |
| | B | 6 |

TABLE 3
Received Conditional Configurations for CPC of PSCell C3

| | Parameter Name | Value |
|---|---|---|
| Conditional Configuration 2 (for PSCell C3) | A | 7 |
| | C | 8 |

At 564, the UE generates roll-back configurations for each target PSCell. These roll-back configurations depend on initial current serving SCG configuration and whether the configuration is changed for a parameter when changing to a target cell. When the parameter is changed relative to the current serving SCG configuration when changing to a target cell, the value of the parameter is included in the roll-back configuration list.

According to some examples, a UE may generate a configuration (“a roll-back configuration”) based on values affected by target CPC configurations for each target PSCell available. This may comprise N target CPC configurations. In some examples, the UE may perform this generation of roll-back configurations when the UE is configured for selective configuration. The UE-generated roll-back configuration list for example i) is shown in Table 4. When the UE applies the roll-back configuration from a new target PSCell, the original source SCG configuration can be obtained.

TABLE 1
UE generated Roll-back Configurations for each target PSCell

| | Parameter Name | Value |
|---|---|---|
| Rollback-Configuration-1(For switching to | A | 1 |
| PSCell C2) | B | 2 |
| Rollback-Configuration-2(For switching to | A | 1 |
| PSCell C3) | C | 3 |

In 564, for C2 parameter the value in C is not part of rollback configuration as this is a field that the network would want the UE to maintain (i.e. Need “M”). If the field has Abstract Syntax Notation 1 (ASN1) type Need “R” then absence of this in delta signalling implies UE should release this field. In this case, the rollback configuration needs to store the field as this would have to be restored back during the configuration rollback. Similarly, Need “N” and Need “S” ASN.1 fields also have to be stored so as to be restored back during the configuration.

FIG. 6 shows an example method performed by a UE. The example method of FIG. 6 may be performed after the method of FIG. 5.

Prior to 666, the UE may determine to switch from the current serving PSCell to a different PSCell. This determination may comprise a determination to perform CPAC execution from the current serving PSCell to the different PSCell.

Upon an initial CPC execution at 666 from the current serving PSCell (the same PSCell serving the UE before 562), the UE selects the roll-back configuration corresponding to a target PSCell X from the Roll-back-configuration-list of 564 and sets this as the reference Roll-back configuration for further PSCell changes. The UE then applies the conditional configuration received for PSCell X and completes the CPAC execution.

For example, at the time of initial CPC execution to target PSCell C2, roll-back-configuration generated for this target PSCell is set as reference roll-back configuration. Then, later when the UE switches from PSCell C2 to PSCell C3, the UE first applies the rollback to source-configuration using the reference roll-back configuration and apply C3 configuration. After successful execution, the roll-back-configuration generated for C3 is set as reference-rollback-configuration for further switching.

In the example of example i), switching to cell C2 is performed, and the reference Roll-back configuration of 666 would be Rollback-Configuration-1 of Table 4. If switching was performed to cell C3, the reference Roll-back configuration would be Rollback-Configuration-2 of Table 4. The conditional configuration for completing execution to cell X=C2 is shown in Table 5.

TABLE 5
CPC execution from C1 to C2

| | Parameter Name | Value |
|---|---|---|
| Serving PSCell Configuration (C2) | A | 5 |
| | B | 6 |
| | C | 3 |

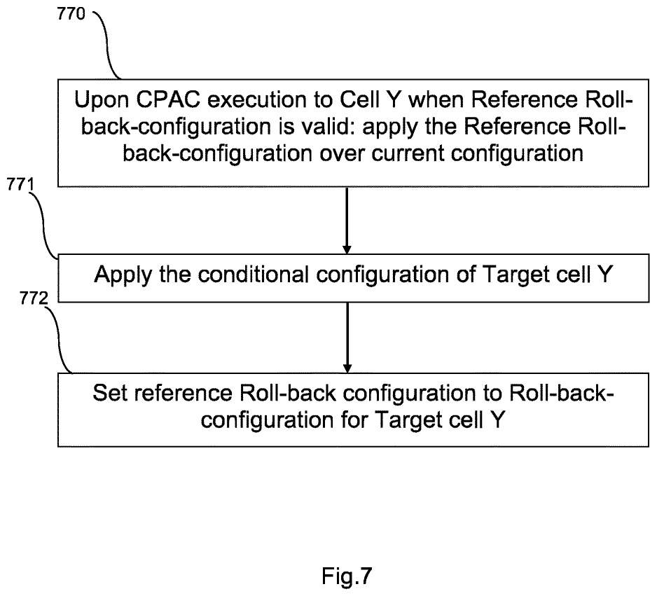

FIG. 7 shows an example method performed by a UE. The example method of FIG. 7 may be performed after the method of FIG. 6. The examples method of FIG. 7 provides a method for CPAC execution to Target cell Y after CPAC execution to Target cell X in FIG. 6.

Upon CPAC execution to Target cell Y, at 770 the reference Roll-back-configuration is applied to the current configuration. This returns the UE to the conditional configuration of the initial serving cell prior to 562.

At 771, the conditional configuration of Target cell Y is applied to the UE. Considering example i), if target cell=Y, the configuration changes performed at 770 and 771 are shown in Table 6.

TABLE 6
Configuration changes for C2 to C3

| | Parameter | Value | Final |
|---|---|---|---|
| | Name | Changes | Value |
| 770: Apply Rollback Configuration | A | 5−>1 | 1 |
| | B | 6−>2 | 2 |
| | C | Unaffected | 3 |
| 771: Apply Conditional Configuration | A | 1−>7 | 7 |
| 2 of cell 3 after rollback | B | Unaffected | 2 |
| | C | 3−>8 | 8 |

At 772, the UE sets the new reference Roll-back configuration to the Roll-back configuration of Target cell 7 (in example i), this is Rollback-Configuration-2).

In some examples, the UE may later perform CPAC execution back to C1. For example, in example i) if CPAC execution is performed from C3 to C1, the configuration changes shown in Table 7 may be performed.

TABLE 7
Configuration changes for C3 to C1

| | | Value | Final |
|---|---|---|---|
| | Parameter Name | Change | Value |
| Apply Rollback Configuration | A | 7−>1 | 1 |
| | B | Unaffected | 2 |
| | C | 8−>3 | 3 |

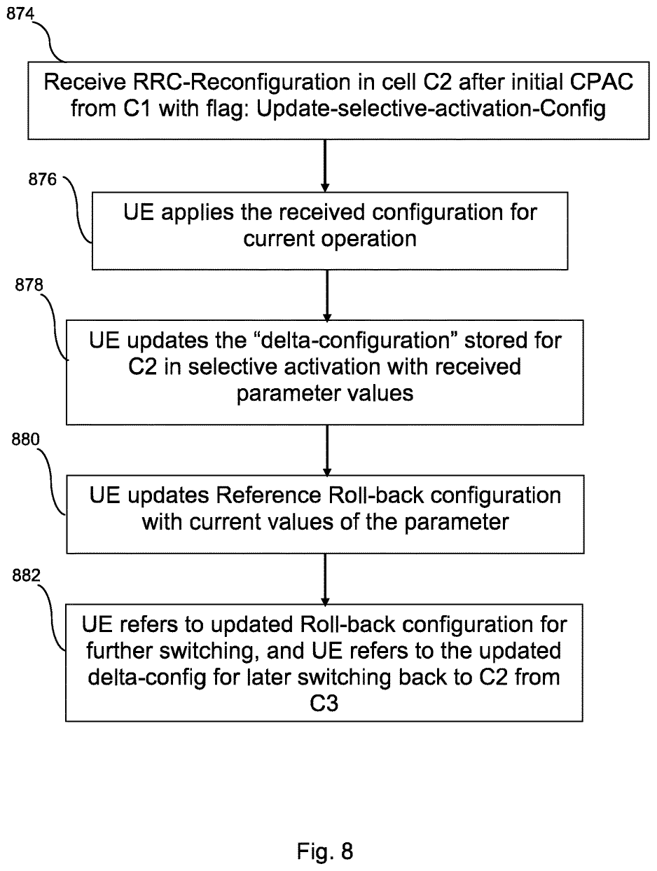

FIG. 8 shows a method that can be performed when a current serving SCG configuration changes. In the example of FIG. 8, it is assumed that the current serving cell is C2 and that there is a configuration update in C2. When current serving SCG configuration changes, the UE can also update the reference roll-back configuration and the pending target-cell configuration for selective switching so that CPC execution later to the same cell will have the latest configuration used in the cell.

At 874, an RRC reconfiguration is received in cell C2. This may be performed after initial CPAC from C1. The initial CPAC may have comprised a flag Update-selective-activation-Config.

At 876, the UE applies the received configuration for the operation reconfiguring cell C2.

At 878, the UE updates the delta configuration stored for C2 in selective activation with the received parameter values.

At 880, the UE updates the Reference-roll-back configuration using the current parameter values in C2. This may be performed in a similar way to 564 using the new parameter values of cell C2, with C2 as the serving cell rather than C1.

At 882, the UE refers to updated roll-back configuration for further switching, and the UE refers to the updated delta-config for later switching back to C2 from C3 or C1.

When current serving SCG configuration changes, the UE can also update the reference roll-back configuration and the pending target-cell configuration for selective switching so that CPC execution later to the same cell will have the latest configuration used in the cell.

Examples described above allow fast configuration switches of a UE. This reduces processing requirements at the UE, as fewer configuration changes are required (by performing delta configuration changes).

To indicate the capability of the UE to perform at least one of the methods described above with respect to the FIGS. 5, 6 and 7, in some examples the UE may send an indication of the fast configuration switching capability to a Master Node (MN) as part of a capability enquiry procedure. In some examples the MN may indicate this capability to other nodes. Based on receiving the indication of the UE's capability, a node operating the target cell may provide a delta configuration for the target cell rather than a full configuration.

To indicate the capability of the UE to perform at least one of the methods described above with respect to the FIGS. 5, 6 and 7, in some examples the UE may send an indication about the capability to the serving cell. The serving MN or Secondary Node (SN) can send a flag or indicator to other network nodes (including other target cells). In some examples the flag may be called “update-selective-activation-config” or the indicator is set to a value which corresponds to “update-selective-activation-config”, to enable the capability. Based on receiving the indication of the UE's capability, a target cell may provide a delta configuration for the target cell rather than a full configuration.

To indicate the capability of the UE to perform at least one of the methods described above with respect to the FIGS. 5, 6 and 7, in some examples the MN may include the capability of the UE to SN (which may include a target cell) when preparing target cells for selective activation and the SN can decide to include Full-configuration or Delta-configuration based on this capability. Based on receiving the indication of the UE's capability, a target cell may provide a delta configuration for the target cell rather than a full configuration.

To indicate the capability of the UE to perform at least one of the methods described above with respect to the FIG. 8, i.e., to indicate that the UE can update a stored configuration, in some examples the MN determines to send an RRC Reconfiguration message to modify the serving cell parameter of the UE if the UE supports the update of stored configurations for selective activation. The MN may receive an indication that this UE supports the update of stored configurations for selective activation from the UE. Otherwise MN will first modify the configurations of target PScells for the changes and trigger RRC Reconfiguration including the modified configurations for selective activation.

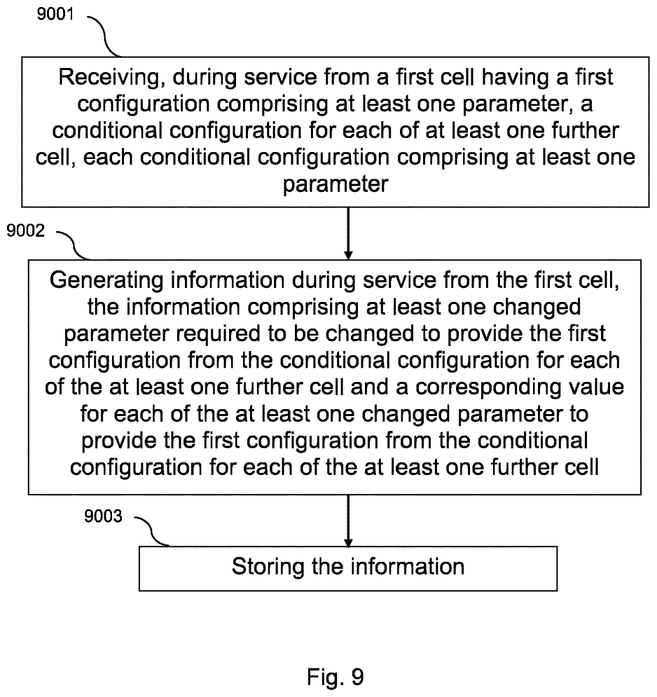

FIG. 9 shows an example method flow. In some examples, the method of FIG. 9 may be performed by a UE.

At 9001, the method comprises receiving, during service from a first cell having a first configuration comprising at least one parameter, a conditional configuration for each of at least one further cell, each conditional configuration comprising at least one parameter.

At 9002, the method comprises: generating information during service from the first cell, the information comprising at least one changed parameter required to be changed to provide the first configuration from the conditional configuration for each of the at least one further cell and a corresponding value for each of the at least one changed parameter to provide the first configuration from the conditional configuration for each of the at least one further cell.

At 9003, the method comprises storing the information.

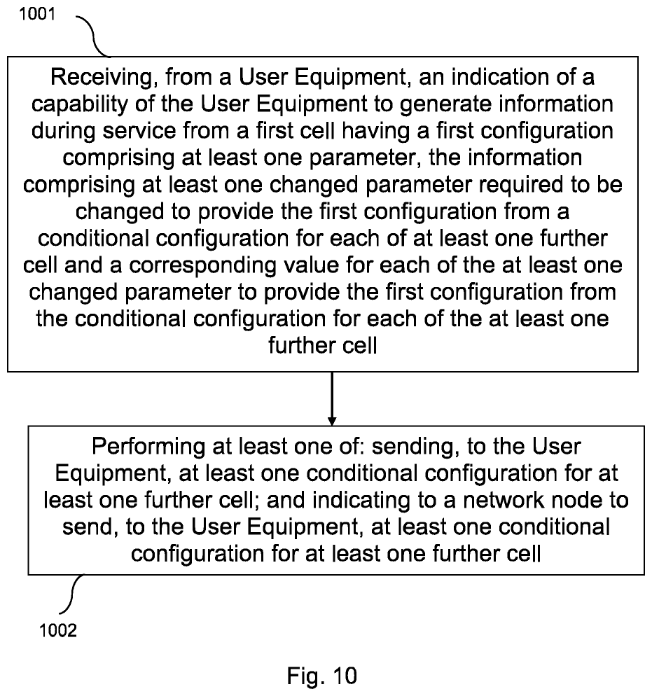

FIG. 10 shows an example method flow. In some examples, the method of FIG. 10 may be performed by a MN.

At 1001, the method comprises receiving, from a User Equipment, an indication of a capability of the User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell.

At 1002, the method comprises performing one or more of: sending, to the User Equipment, at least one conditional configuration for at least one further cell; and indicating to a network node to send, to the User Equipment, at least one conditional configuration for at least one further cell.

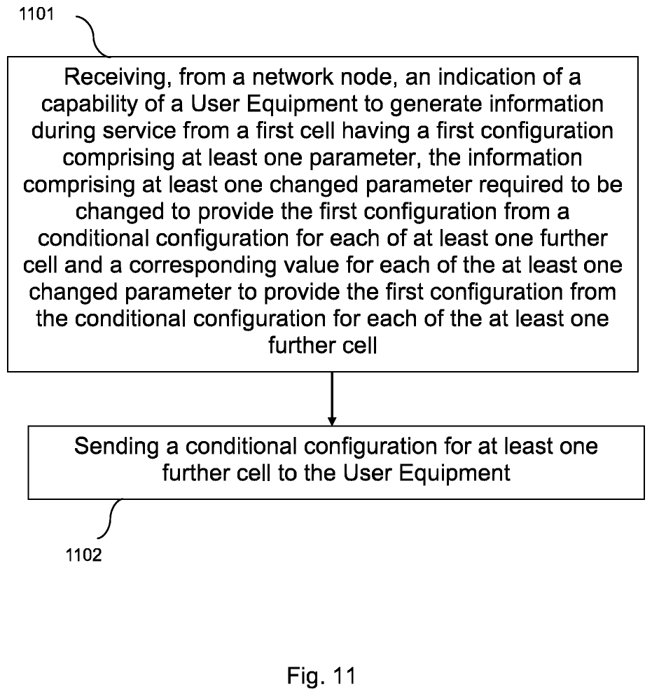

FIG. 11 shows an example method flow. In some examples, the method of FIG. 11 may be performed by a SN.

At 1101, the method comprises receiving, from a network node, an indication of a capability of a User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell.

At 1102, the method comprises sending a conditional configuration for at least one further cell to the User Equipment.

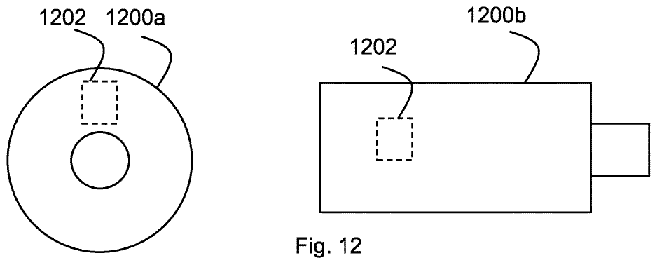

FIG. 12 shows a schematic representation of non-volatile memory media 1200a (e.g. computer disc (CD) or digital versatile disc (DVD)) and 1200b (e.g. universal serial bus (USB) memory stick) storing instructions and/or parameters 1202 which when executed by a processor allow the processor to perform one or more of the steps of the above-described methods.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process.

Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. A method comprising:
receiving, during service from a first cell having a first configuration comprising at least one parameter, a conditional configuration for each of at least one further cell, each conditional configuration comprising at least one parameter;
generating information during service from the first cell, the information comprising at least one changed parameter required to be changed to provide the first configuration from the conditional configuration for each of the at least one further cell and a corresponding value for each of the at least one changed parameter to provide the first configuration from the conditional configuration for each of the at least one further cell; and
storing the information.

2-24. (canceled)

25. An apparatus comprising:
at least one processor; and
at least one memory including computer program code;
the at least one memory and the computer program code configured to, with the at least one processor, cause the apparatus at least to perform:
receiving, during service from a first cell having a first configuration comprising at least one parameter, a conditional configuration for each of at least one further cell, each conditional configuration comprising at least one parameter;
generating information during service from the first cell, the information comprising at least one changed parameter required to be changed to provide the first configuration from the conditional configuration for each of the at least one further cell and a corresponding value for each of the at least one changed parameter to provide the first configuration from the conditional configuration for each of the at least one further cell; and
storing the information.

26. An apparatus according to claim 25, wherein the at least one memory and the computer program code are configured to, with the at least one processor, cause the apparatus at least to perform: receiving an indication from a network node to preserve configurations when switching service from the first cell to the at least one further cell.

27. An apparatus to claim 25, wherein the apparatus comprises a User Equipment.

28. An apparatus according to claim 25, wherein the information is stored in a list comprising a respective entry corresponding to each of the at least one further cell.

29. An apparatus according to claim 25, wherein the at least one memory and the computer program code are configured to, with the at least one processor, cause the apparatus at least to perform:
determining to switch to service from the first cell to service from a second cell, the at least one further cell comprising the second cell;
based on the information, storing a reference configuration for changing from the configuration of the second cell to the first configuration of the first cell; and
switching to service to the second cell and applying the configuration of the second cell.

30. An apparatus according to claim 29, wherein the at least one memory and the computer program code are configured to, with the at least one processor, cause the apparatus at least to perform:
determining to switch to service from the second cell to service from the third cell, the at least one further cell comprising the third cell;
applying the reference configuration to change to the first configuration of the first cell and then applying the configuration of the third cell to change to the configuration of the third cell;
based on the information, storing a new reference configuration for changing from the configuration of the third cell to the first configuration of the first cell.

31. An apparatus according to claim 29, wherein the at least one memory and the computer program code are configured to, with the at least one processor, cause the apparatus at least to perform:
receiving an updated configuration for the second cell;
applying the updated configuration for the second cell;
updating the information based on the updated configuration of the second cell;
updating, based on the updated information, the reference configuration for changing from the configuration of the second cell to the first configuration of the first cell.

32. An apparatus according to claim 31, wherein the at least one memory and the computer program code are configured to, with the at least one processor, cause the apparatus at least to perform:
sending, to the network node, an indication indicating an update, based on the updated information, of the reference configuration for changing from the configuration of the second cell to the first configuration of the first cell; and wherein:
the receiving an updated configuration for the second cell comprises receiving a signalling message from the network node, wherein the network node determines to send the signalling message based on receiving a capability indication from the user equipment.

33. An apparatus according to claim 25, wherein each conditional configuration is a delta configuration describing a parameter change required to change from the first configuration to the conditional configuration.

34. An apparatus according to claim 25, wherein the at least one memory and the computer program code are configured to, with the at least one processor, cause the apparatus at least to perform:
sending to a network node, an indication of the capability of generating information for changing of each the at least one changed parameter from the conditional configuration for each of the least one further cell to the first configuration.

35. An apparatus according to claim 34, wherein the network node indicates the capability to at least one other network node.

36. An apparatus according to claim 35, wherein the at least one other network node determines whether to send a full configuration describing each parameter of a configuration of the network node or a delta configuration describing a parameter change required to change from the first configuration to the configuration of the network node.

37. An apparatus according to claim 25, wherein the first cell comprises a PSCell and the at least one further cell comprises a PSCell.

38. An apparatus according to claim 25, wherein each of the first cell and the at least one further cell belong to a different Secondary Cell Group.

39. An apparatus comprising:
at least one processor; and
at least one memory including computer program code;
the at least one memory and the computer program code configured to, with the at least one processor, cause the apparatus at least to perform:
receiving, from a User Equipment, an indication of a capability of the User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and
performing at least one of: sending, to the User Equipment, at least one conditional configuration for at least one further cell; and indicating to a network node to send, to the User Equipment, at least one conditional configuration for at least one further cell.

40. An apparatus according to claim 39, wherein the at least one memory and the computer program code are configured to, with the at least one processor, cause the apparatus at least to perform:
sending, to the User Equipment, a request for the indication of the capability of the User Equipment to generate the information.

41. An apparatus according to claim 3, wherein the at least one memory and the computer program code are configured to, with the at least one processor, cause the apparatus at least to perform:
sending, to at least one network node, the indication of the capability of the User Equipment to generate the information.

42. An apparatus according to claim 39, wherein the at least one memory and the computer program code are configured to, with the at least one processor, cause the apparatus at least to perform:
receiving a second indication from the User Equipment, the second indication indicating a capability of the User Equipment to update the first configuration;
sending signalling to the User Equipment to update the first configuration.

43. An apparatus according to claim 42, wherein the signalling comprises an RRC message.

44. An apparatus according to claim 39, wherein the apparatus comprises a MN.

45. An apparatus according to claim 39, wherein the network node comprises an SN.

46. An apparatus comprising:
at least one processor; and
at least one memory including computer program code;
the at least one memory and the computer program code configured to, with the at least one processor, cause the apparatus at least to perform:
receiving, from a network node, an indication of a capability of a User Equipment to generate information during service from a first cell having a first configuration comprising at least one parameter, the information comprising at least one changed parameter required to be changed to provide the first configuration from a conditional configuration for each of at least one further cell and a corresponding value for each of the at least one changed parameter to provide the first configuration from the conditional configuration for each of the at least one further cell; and
sending a conditional configuration for at least one further cell to the User Equipment.

47. An apparatus according to claim 46, wherein the conditional configuration comprises a delta configuration describing a parameter change required to change from the first configuration to the conditional configuration.

48. An apparatus according to claim 46, wherein the apparatus comprises a SN.

49. An apparatus according to claim 46, wherein the network node comprises an MN.

50. A non-transitory computer readable medium comprising program instructions that, when executed by at least one processor, cause an apparatus at least to perform the method according to claim 1.

51. (canceled)

52. (canceled)
